(19) United States
(12) Patent Application Publication
(10) Pub. No.: US 2018/0224379 A1
(43) Pub. Date: Aug. 9, 2018

(54) METHOD AND COMPOSITION FOR DETECTING COPPER

(71) Applicant: CAPE BRETON UNIVERSITY, Sydney (CA)

(72) Inventors: Xu ZHANG, Sydney (CA); Zhi SHAN, Sydney (CA)

(21) Appl. No.: 15/748,105

(22) PCT Filed: Jul. 28, 2016
(86) PCT No.: PCT/CA2016/050889

§ 371 Date: Jan. 29, 2018

Related U.S. Application Data
(60) Provisional application No. 62/197,922, filed on Jul. 28, 2015.

(51) Int. Cl. G01N 21/78; G01N 31/22

(52) U.S. Cl. CPC G01N 21/78; G01N 31/22

(57) ABSTRACT

Disclosed herein is a method for detecting copper(II) in a liquid sample. The method generally comprises contacting a liquid sample, such as water, with a chromogen, such as TMB, in the presence of a suitable halide, such as chloride or bromide, and an oxidizer, such as hydrogen peroxide; and detecting a color change of the chromogen. A color change signifies the presence of copper in the sample. Compositions and kits are also provided. The presence of said suitable halide was found to amplify the detection signal.

### CROSS REFERENCE TO RELATED APPLICATIONS

This application claims the benefit of priority of U.S. Provisional Patent Application No. 62/197,922, filed Jul. 28, 2015, which is incorporated herein by reference in its entirety.

### FIELD

The present disclosure relates generally to methods and compositions for detecting copper in a liquid sample.

### BACKGROUND

Copper(II), an essential cofactor of many metalloenzymes catalyzing numerous metabolic reactions, is capable of enhancing hydroxyl radical production from hydrogen peroxide, a property implicated in the progression of neurodegenerative disorders including Alzheimer's, Parkinson's, and Wilson's diseases with long-term exposure to even trace levels.¹ Due to its environmental and biological importance, the past decades have witnessed a large number of reports on the design of Cu(II) sensors with improved simplicity.² To achieve good sensitivity, a variety of signal amplification strategies were adopted in the sensor design. For example, transducing materials with high extinction coefficients or optoelectronic properties were introduced such as gold nanoparticles^{2a-c} and quantum dots^{2d-f} for designing colorimetric and fluorescence sensors, respectively. The role that copper plays in the signal development is a critical determinant of sensitivity. When copper serves as the reactant, usually the chemsensor generates signal in a defined stoichiometric ratio to Cu(II) (usually 1:1),³ thus limiting sensitivity. In contrast, when copper is used as a catalyst in the color producing reaction, sensor sensitivity and selectivity can be dramatically improved via catalytic signal amplification. For example, Cu(II) assisted with peptide,^{2f} DNAzyme,^{2g,2h} GpG DNA duplex,²ⁱ metalloenzyme,^{2j} and organic dyes^{2k,2l} have been used to catalyse various color developing reactions, including DNA cleavage,^{2c,2g,2h} spirolactam ring-opening, hydrolysis of α-amino acid esters,^{2m,2n} oxidative cyclization of azoaromatics,^{2o} cysteine oxidation,^{2b,2p} the azide alkyne Huisgen cycloaddition reaction^{,2a,2q-s} and Fenton reactions.^{2c,2k} Nevertheless, most approaches are not time- and cost-effective, have limited sensitivity, or require use of toxic chemicals. Improved copper(II) detection methods are desirable.

### SUMMARY

It is a goal of the present disclosure to obviate or mitigate at least one disadvantage of previous copper detection methods.

In one aspect of the present disclosure, there is provided a method for detecting copper(II) in a liquid sample, comprising: contacting the liquid sample with a chromogen in the presence of a suitable halide and an oxidizer; and detecting a color change of the chromogen; wherein the color change when present indicates the presence of copper in the liquid sample.

In another aspect of the present disclosure, there is provided a method for detecting copper(II) in a liquid sample, comprising: combining a chromogen and a suitable halide in a suitable medium to create a mixture solution; contacting the mixture solution and the liquid sample to create a reaction solution; adding an oxidizer to the reaction solution; and detecting a color change of the chromogen, wherein the color change when present indicates the presence of copper.

In another aspect of the present disclosure, there is provided composition for detecting copper(II) in a liquid sample, comprising: a suitable halide; a chromogen; and an oxidizer, wherein the chromogen undergoes a color change in the presence of copper.

In another aspect of the present disclosure, there is provided a kit for detecting copper(II) in a liquid sample, the kit comprising: a first container comprising a suitable halide; a second container comprising a chromogen; and a third container comprising an oxidizer; and a set of instructions for carrying out a method of detecting copper in a liquid sample.

In some embodiments, the halide is chloride or bromide.

In some embodiments, the oxidizer is hydrogen peroxide.

In some embodiments, the chromogen is TMB.

In some embodiments, the concentration of the halide in salt form is between about 1 mM and about 1000 mM.

In some embodiments, the concentration of the oxidizer is between about 1 mM and about 5000 mM.

In some embodiments, the concentration of the chromogen is between about 0.01 mM and about 1.00 mM.

In some embodiments, the liquid sample is water.

In some embodiments, copper is detected visually.

In some embodiments, copper is detected instrumentally.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a graph showing 3,3′,5,5′-tetramethylbenzidine (TMB) oxidation kinetics catalysed by different concentrations of Cu(II) via Cu-Fenton chemistry. The dashed arrow indicates increasing concentrations of Cu(II). FIG. 1 insert is a graph of the absorbance of ox-TMB versus [Cu (II)].

FIG. 2 is a picture of a colorimetric assay of Cu(II) based on Cu-Fenton chemistry.

FIG. 3 is a graph of the A652 (indicator of ox-TMB) generated in the presence of various metal ions (10 μM) in the TMB-H₂O₂ system.

FIG. 4 is a graph of the absorbance of ox-TMB catalyzed by different concentration of Cu(II) in the presence/absence of NaCl.

FIG. 5 is a picture of a colorimetric assay of Cu(II) based on chloride amplified Cu-Fenton (CA Cu-Fenton) reaction.

FIG. 6 is a graph of the Cu(II) detection limit relative to NaCl concentration.

FIG. 7 is a graph of the kinetics of TMB oxidation catalysed by different concentrations of Cu(II) in the presence of 100 mM NaCl. The dashed arrow indicates increasing concentrations of Cu(II). FIG. 7 inset is a graph of the responses at low Cu(II) levels. The dashed arrow indicates increasing concentrations of Cu(II).

FIG. 8 is a graph of TMB oxidation catalyzed by CA Cu-Fenton with varying Cu(II) and NaCl concentrations.

FIG. 9 is a graph of the effects of different anions and cations on TMB oxidation.

FIG. 10 is a graph of the absorbance of different oxidized chromogenic substrates.

FIG. 11 is a graph of selectivity of an assay for Cu(II) against other metal cations.

FIG. 12 is a graph of the signal amplification of NaCl activated Cu-Fenton reaction (10 min) under different pH regimes.

FIG. 13 is a graph of the hydroxyl radical yield detected with terephthalic acid (TPA) as a function of Cu(II) concentration with or without NaCl.

FIG. 14 is a graph of the effect of NaCl concentration on the .OH production under different pHs in the CA Cu-Fenton system. FIG. 14 inset is a graph of the .OH production with ≤100 mM NaCl.

FIG. 15 is a graph of the scavenging effect of propanol, mannitol and tert-butyl alcohol (TBA) on TMB oxidation in CA Cu-Fenton systems.

FIG. 16 is an illustration of the chemical reaction of relevant species with reaction constants or pKₐ.

FIG. 17 is a graph of the UV-vis spectra of TMB at 1- and 40-mins of incubation with 3M H₂O₂ in 2 mM 2-(N-morpholino)ethanesulfonic acid (MES), pH 5.5.

FIG. 18 is a graph of the fluorescence spectra of TPA/H₂O₂ irradiated at 365 nm for 150 s at the presence of different concentrations of NaCl. The dashed arrow indicates increasing concentrations of NaCl. FIG. 18 inset is a graph of a plot of the emission at 420 nm.

FIG. 19 is a graph of the UV-vis absorbance spectra of TMB oxidation by H₂O₂ in photo-Fenton reaction where the samples were irradiated at 365 nm for 150 s with different concentrations of NaCl. The dashed arrow indicates increasing concentrations of NaCl. FIG. 19 inset is a graph of a plot of the A650 (indication of the ox-TMB concentration) versus the concentration of NaCl.

FIG. 20 is a graph of the calculated Cu(II) species formation and distribution at pH 5.5 under variable initial NaCl concentrations from 0-1.0M using PhreeqC modelling code.

FIG. 21 is a graph of the UV-vis spectra of Cu (II)-chloride complex in 2 mM MES buffer (pH 5.5). The dashed arrow indicates increasing concentrations of NaCl.

FIG. 22 is a graph of a plot of the initial rate of TMB oxidation versus NaCl concentration at different Cu(II) concentrations.

FIG. 23 is a graph of the turnover frequency (TOF) of CA-Cu-Fenton reaction with different concentrations of NaCl.

FIG. 24 is an illustration of the mechanism of Cu-Fenton and Chloride amplified Cu-Fenton reaction on the oxidation of TMB.

FIG. 25 is a graph of the effect of different halide ions on TMB oxidation.

### DETAILED DESCRIPTION

Generally, the present disclosure provides a method for detecting copper(II) in a liquid sample. Compositions and kits are also disclosed. The detection is believed to involve a signal-amplification mechanism involving reactive halide species (RHSs), which amplify copper-Fenton reactions, oxidizing a chromogenic substrate to develop a color that signifies the presence of copper. Without being bound by theory, it is believed that the copper ions catalyze the oxidation of halide by the oxidizer, such as hydrogen peroxide (H₂O₂), to form reactive halide species, which then oxidize the chromogen to generate a colored oxidized product.

In one aspect, the disclosure provides a method for detecting copper(II) in a liquid sample. The method comprises contacting the liquid sample with a chromogen in the presence of a suitable halide, and an oxidizer; and detecting a color change of the chromogen; wherein the color change when present indicates the presence of copper in the liquid sample.

In another aspect, the disclosure provides a composition for detecting copper(II) in a liquid sample. The composition comprises a chromogen, a suitable halide, and an oxidizer, where the chromogen undergoes a color change in the presence of copper.

The liquid sample may be any suitable liquid that is suspected of containing copper(II). Examples include water, such as drinking water, ground water, tap water, laboratory water, river water, pond water, wastewater, industry water, stream water, wetland water, ocean water, coastal water, estuary water and beach water. Additional types of liquid samples may include biological fluids, such as blood, urine and serum. A skilled person would be capable of modifying the methods and compositions depending on the type of liquid sample being tested. For example, the concentration of halide in the form of NaCl may be reduced when ocean water is being sampled.

The step of contacting may include but is not limited to mixing, combining, reacting, incubating, and the like. The contacting may take place in one or multiple steps and may involve one or multiple solutions. In some embodiments, the step of contacting may comprise incubating for a sufficient time and under suitable conditions to permit a chromogenic reaction to occur. In one embodiment, the step of contacting may comprise making a first solution containing a first ingredient, a second solution containing a second ingredient, and combining the two. Alternatively, in some embodiments, multiple ingredients may be combined in a single solution to form a mixture.

The contacting may take place in any suitable container. In some embodiments, the container is a container that facilitates visual or instrumental detection of color change. In some embodiments, the container is a clear vial or tube, such as an Eppendorf tube. In some embodiments, the container is a plate well, such as a well of a 96-well plate.

In the context of the present disclosure, a suitable halide is a halide compound that can undergo oxidation. For example, the halide may be chloride or bromide. In some embodiments, the halide is chloride. In some examples, the halide is provided as a salt. In some embodiments, the halide is provided as a chloride salt, for example, NaCl, LiCl, KCl, CaCl₂, MgCl₂, KBr, NaBr, or CaBr₂. In some embodiments, the halide is provided as NaCl.

In the context of the present disclosure, a suitable oxidizer is an oxidizer that is capable of driving a chromogenic reaction as described herein. In particular, the oxidizer is capable of oxidizing a halide. The oxidizer is preferably one whose ability to oxidize halide is enhanced in the presence of copper ions. The oxidizer may, for example, be a peroxide or an acid (e.g. HCl). In some embodiments, the oxidizer is a peroxide. In some embodiments, the peroxide is hydrogen peroxide (H₂O₂) or another inorganic peroxide. In some embodiments, the oxidizer is hydrogen peroxide (H₂O₂).

In the context of the present disclosure, the chromogen is any suitable chromogen that undergoes a color change when oxidized. Examples of chromogens include but are not limited to 3,3′,5,5′-tetramethylbenzidine (TMB), 3,3′-Dichlorobenzidine, aniline and its derivatives, e.g., o-Phenylenediamine, benzidine and its derivatives, e.g., o-tolidine, o-dianisidine (ODA), 3,3′-Diaminobenzidine (DAB), and other substrates generally used for peroxidase enzyme, e.g., 2,2′-azino-bis(3-ethylbenzothiazoline-6-sulphonic acid (ABTS), guaiacol, and o-phenylenediamine (OPD). In some embodiments, the chromogen may be one that can serve as a substrate for peroxidase enzymes, such as Horseradish peroxidase (HRP). In some embodiments, the chromogen is TMB.

In some embodiments, the halide is Cl or Br, the oxidizer is hydrogen peroxide and the chromogen is TMB. Without wishing to be bound by theory, it is believed that the copper ions catalyze the oxidation of halide by the oxidizer to form reactive halide species (RHS), which then oxidizes the chromogen to generate a colored oxidized product. In the case of chloride, the process is believed to start from forming a CuCl+ or CuBr+ complex, respectively, which catalyzes the decomposition of the oxidizer, e.g. H₂O₂ to generate active hydroxyl radicals (.HO), followed by oxidation of chloride or bromide by .HO to form a reactive halide species, which then oxidizes the chromogen. In the case of TMB, oxidization forms a bluish product.

The color change may be detected by any means known in the art. For example, a color change may be detected by an instrument or detected visually. In some embodiments, the color change is detected by an instrument. In some embodiments, the color change is detected visually. The limit of detection (LOD) of the method will vary depending on the means of detection. In some embodiments, the LOD is about 500 nM, about 100 nM, about 70 nM, about 40 nM, about 20 nM, about 10 nM, about 5 nM, about 1 nM, about 0.5 nM, about 0.1 nM, or about 0.01 nM, or the LOD is from any of the LODs listed above to any other of the LODs listed above. In some embodiments, the LOD is in the range of about 50 nM to about 0.01 nM, about 40 nM to about 10 nM, about 10 nM to about 1 nM, or about 1 nM to about 0.01 nM. For example, in some cases, the LOD of an instrumental detection assay in accordance with embodiments of the present disclosure may be lower than about 10, 5, 1, 0.5, 0.3 or 0.1 nM. In some cases, the LOD of a visual detection assay may be lower than about 1000, 500, 100 or 50 nM.

The amount of oxidized chromogen in the sample may be used to estimate the amount of copper present. If desired, the color change in a sample may be compared to a control or series of controls, for example, in order to determine whether a particular threshold of oxidized chromogen in the sample is reached. If desired, the amount of oxidized chromogen in a sample may be quantified, for example, by comparing the sample against a standard curve.

A skilled person would understand that instrumental detection includes any suitable detection method for determining the concentration of a chromogenic compound in a solution, for example, any instrument that measures spectrum. In some embodiments, the instrument is a plate reader. In some embodiments, the instrumental detection is colorimetric analysis. In other embodiments, the instrumental detection is UV-Vis spectroscopy. In further embodiments, the instrument detection is fluorescence spectroscopy. In yet further embodiments, the color change of the chromogen is detected visually.

A skilled person would understand that the optimal absorbance to monitor color change of the chromogen will depend on the particular chromogen selected. In some embodiments, the peak absorbance of a particular chromogen is selected. In some embodiments, the absorbance is measured between about 350 nm and about 390 nm, between about 440 nm and about 460 nm, or between about 610 nm and about 670 nm. In some embodiments, the absorbance is measured at about 650 nm.

In one embodiment, the disclosure provides a method for detecting copper(II) in a liquid sample that comprises contacting a suitable halide with a suitable chromogen to create a mixture solution, adding the mixture solution to the liquid sample to create a reaction solution, adding a suitable oxidizer to the reaction solution; and measuring a color change of the chromogen, where the color change signifies the presence of copper.

In another embodiment, the disclosure provides a method for detecting copper(II) in a liquid sample comprising contacting a suitable halide with the liquid sample to create a mixture solution, adding a suitable chromogen to the mixture solution to create a reaction solution, adding a suitable oxidizer to the reaction solution; and measuring a color change of the chromogen, where the color change signifies the presence of copper.

In another embodiment, the disclosure provides a method for detecting copper(II) in a liquid sample comprising contacting a suitable chromogen with the liquid sample to create a mixture solution, adding a suitable halide to the mixture solution to create a reaction solution, adding a suitable oxidizer to the reaction solution; and measuring a color change of the chromogen, where the color change signifies the presence of copper.

In another embodiment, the disclosure provides a method for detecting copper(II) in a liquid sample comprising contacting a suitable halide with a suitable chromogen and the liquid sample to create a reaction solution, adding a suitable oxidizer to the reaction solution; and measuring a color change of the chromogen, where the color change signifies the presence of copper.

In another embodiment, the disclosure provides a method for detecting copper(II) in a liquid sample comprising contacting a suitable halide with a suitable chromogen, the liquid sample, and a suitable oxidizer to create a reaction solution; and measuring a color change of the chromogen, where the color change signifies the presence of copper.

In some embodiments, the disclosure provides a method that may be used to determine the concentration of copper(II) in a water sample by visual detection. In some examples, the method includes combining TMB with NaCl, e.g. mixing a TMB solution with a NaCl solution. In some examples, the mixing is performed in a clear vial or tube, or a plate well, for example, a clear 96-well plate. In one example, the TMB and NaCl are combined to a final concentration of about 0.5 mM TMB and 50 mM NaCl. Next, a water sample and hydrogen peroxide solution are added to the TMB-NaCl solution to create a mixture, which is ideally stored in a dark environment for a length of time to allow the TMB to change color. In some examples, the length of time is about 5 minutes. A bluish color signifies that copper is present in the water sample. The color of the mixture may be compared with a color code bar of known copper concentrations to determine the concentration of copper in the water sample.

In other embodiments, the disclosure provides a method that may be used to determine the concentration of copper(II) in a water sample by instrumental detection. In one embodiment, the method includes combining TMB and NaCl, e.g. mixing a TMB solution with a NaCl solution. In some examples, the mixing is performed in a clear vial or tube, or a plate well, for example, a clear 96-well plate. In one example, the TMB and NaCl are combined to a final concentration of about 0.5 mM TMB and about 50 mM NaCl. Next, a water sample and hydrogen peroxide solution are added to the TMB-NaCl solution to create a mixture, which is ideally stored in a dark environment for a length of time to allow the TMB to change color. In some examples, the length of time is about 5 minutes. The method may comprise creating a set of standard solutions containing a known concentration of copper ions in pure water and a TMB stock solution and NaCl solution as described above, which may be used to create an external calibration curve. The standard solutions may be stored in a dark environment. Next, HCl or H₂SO₄ may be added to the mixture to terminate the reaction. The addition of HCl or H₂SO₄ may convert the bluish color of the mixture to a yellow color. The light absorbance of the mixture may be measured to determine the concentration of the copper at, for example, a wavelength of about 650 nm if HCl or H₂SO₄ was not added to the mixture, or a wavelength of about 370 nm if HCl or H₂SO₄ was added to the mixture. The absorbance of the mixture may be compared to the absorbances of the external calibration curve to more accurately determine the concentration of the copper in the water sample.

In further embodiments, the method may be used to determine the concentration of copper(II) in serum samples by instrumental detection. In one embodiment, the method includes combining TMB and NaCl, e.g. mixing a TMB solution with a NaCl solution. In some examples, the mixing is performed in a clear vial or tube, or a plate well, for example, a clear 96-well plate. In one example, the TMB and NaCl are combined to a final concentration of about 0.5 mM TMB and about 50 mM NaCl. Next, a serum sample and hydrogen peroxide solution are added to the TMB-NaCl solution to create a mixture, which is ideally stored in a dark environment for a length of time to allow the TMB to change color. In some examples, the length of time is about 5 minutes. The method may comprise creating a set of standard solutions, containing a known concentration of copper ions in serum and a TMB stock solution and NaCl solution as described above, which may be used to create an external calibration curve. The standard solutions may be stored in a dark environment. The light absorbance of the mixture may be measured to determine the concentration of the copper at, for example, a wavelength of about 650 nm. The absorbance of the mixture may be compared to the absorbances of the external calibration curve to more accurately determine the concentration of the copper in the sample.

In some embodiments, the concentration of the suitable halide in salt form, is between about 1 mM and about 1000 mM, for example, 1 mM, 10 mM, 15 mM, 25 mM, 50 mM, 75 mM, 100 mM, 150 mM, 200 mM, 250 mM, 500 mM, 800 mM, 900 mM, or 1000 mM; or the concentration is from any of the concentrations listed above to any other of the concentrations listed above. In other embodiments, the concentration of the suitable halide in salt form is between about 10 mM and about 250 mM. In further embodiments, the concentration of the suitable halide in salt form is between about 15 mM and about 150 mM. In yet further embodiments, the concentration of the suitable halide in salt form is between about 20 mM and about 120 mM. In other embodiments, the concentration of the suitable halide in salt form is between about 75 mM and about 100 mM.

In some embodiments, the concentration of the suitable oxidizer is between about 1 mM and about 5000 mM, for example, 1 mM, 10 mM, 25 mM, 50 mM, 100 mM, 200 mM, 300 mM, 400 mM, 500 mM, 600 mM, 650 mM, 700 mM, 750 mM, 800 mM, 850 mM, 900 mM, 1000 mM, 1250 mM, 1500 mM, 1750 mM, 2000 mM, 2500 mM, 3000 mM, 3500 mM, 4000 mM, 4500 mM, or 5000 mM; or the concentration is from any of the concentrations listed above to any other of the concentrations listed above. In other embodiments, the concentration of the suitable oxidizer is between about 100 mM and about 3000 mM. In further embodiments, the concentration of the suitable oxidizer is between about 200 mM and about 2000 mM. In yet further embodiments, the concentration of the suitable oxidizer is between about 300 mM and about 1750 mM. In other embodiments, the concentration of the H₂O₂ is between about 500 mM and about 1500 mM. In other embodiments, the concentration of the suitable oxidizer is between about 700 mM and about 800 mM.

In some embodiments, the concentration of the suitable chromogen is between about 0.01 mM and about 1.00 mM, for example, 0.01 mM, 0.05 mM, 0.10 mM, 0.15 mM, 0.20 mM, 0.25 mM, 0.30 mM, 0.35 mM, 0.40 mM, 0.45 mM, 0.50 mM, 0.55 mM, 0.60 mM, 0.65 mM, 0.70 mM, 0.75 mM, 0.80 mM, 0.85 mM, 0.90 mM, 0.95 mM, or 1.00 mM; or the concentration is from any of the concentrations listed above to any other of the concentrations listed above. In other embodiments, the concentration of the suitable chromogen is between about 0.1 mM and about 0.9 mM. In further embodiments, the concentration of the suitable chromogen is between about 0.20 mM and about 0.80 mM. In yet further embodiments, the concentration of the suitable chromogen is between about 0.30 mM and about 0.70 mM. In other embodiments, the concentration of the suitable chromogen is between about 0.40 mM and about 0.60 mM.

The reactions disclosed herein may be carried out for any suitable incubation or reaction time sufficient to permit the chromogenic reaction to take place. In some embodiments, the incubation time is between about 1 second and about 60 minutes, between about 1 second and about 10 minutes, of between about 10 seconds and about 5 minutes, or between about 1 minute and about 5 minutes. In some embodiments, the incubation time is about 1 second, about 10 seconds, about 30 seconds, about 45 seconds, about 1 minute, about 5 minutes, about 10 minutes, about 15 minutes, about 20 minutes, about 25 minutes, about 30 minutes, about 35 minutes, about 40 minutes, about 45 minutes, about 50 minutes, about 55 minutes, or about 60 minutes; or the amount of time is from any of the times listed above to any other of the times listed above.

In some embodiments, the samples and/or controls are incubated in the dark.

In one embodiment, the pH of the assay is between about 2 and about 7, for example, 2, 3, 4, 5, 5.5, 6, or 7; or the pH is from any of the pHs listed above to any other of the pHs listed above. In some embodiments, the pH of the assay is between about 4 and about 6. In other embodiments, the pH of the assay is between about 5 and about 6.

In one embodiment, the concentration of chloride or bromide in salt form is between about 1 mM and about 1000 mM, the concentration of the H₂O₂ is between about 1 mM and 5M, the concentration of the TMB is between about 0.01 mM and about 1 mM, and the pH of the assay is between about 2 and about 7.

In another embodiment, the concentration of the chloride or bromide in salt form is between about 20 mM and about 120 mM, the concentration of the H₂O₂ is between about 500 mM and about 1.5M, the concentration of TMB is between about 0.20 mM and about 0.80 mM, and the pH is between about 5 and about 6.

In another embodiment, the concentration of the chloride or bromide in salt form is between about 75 mM and about 100 mM, the concentration of the H₂O₂ is between about 700 mM and about 800 mM, the concentration of TMB is between about 0.40 mM and about 0.60 mM, and the pH is between about 4 and about 6.

In another embodiment, the concentration of the chloride or bromide in salt form is about 75 mM, the concentration of the H₂O₂ is about 700 mM, the concentration of TMB is about 0.40 mM, and the pH is about 5.5.

In another embodiment, the concentration of the chloride or bromide in salt form is about 85 mM, the concentration of the H₂O₂ is about 750 mM, the concentration of TMB is about 0.50 mM, and the pH is about 5.5.

In another embodiment, the concentration of the chloride or bromide in salt form is about 100 mM, the concentration of the H₂O₂ is about 775 mM, the concentration of TMB is about 0.55 mM, and the pH is about 5.5.

In another embodiment, the concentration of the chloride or bromide in salt form is about 125 mM, the concentration of the H₂O₂ is about 800 mM, the concentration of TMB is about 0.60 mM, and the pH is about 5.5.

In another embodiment, the concentration of the chloride or bromide in salt form is about 150 mM, the concentration of the H₂O₂ is about 750 mM, the concentration of TMB is about 0.50 mM, and the pH is about 5.5.

In another embodiment, the concentration of the chloride or bromide in salt form is about 75 mM, the concentration of the H₂O₂ is about 1.0M, the concentration of TMB is about 0.50 mM, and the pH is about 5.5.

In the context of the present disclosure, a skilled person would understand that the term “about” when used in connection with a range or value means “approximately”, for example, plus or minus 10%.

In the context of the present disclosure, a skilled person would understand that the solutions may be buffered with any suitable buffer that has a low interaction with copper in Fenton reactions. For example, a skilled person would understand that any suitable buffer would contain little or no reductive anions such as citrate or ascorbic acid, little or no complex agents such as ammonium or ammonia, and little or no anions that form precipitates with Cu ions. In some embodiments, acetate buffers may be used. In other embodiments, a 2-(N-morpholino)ethanesulfonic acid (MES) or a 3-(N-morpholino)propanesulfonic acid (MOPS) buffer may be used. In some examples, the buffer has a pH of about 8 or less. In other examples, the buffer has a pH between about 3 and about 6, for example, 3, 3.5, 4, 4.5, 5, 5.5, or 6; or the pH is from any of the pHs listed above to any other of the pHs listed above. In other embodiments, the solutions may be water.

In the context of the present disclosure, a skilled person would understand that the temperature and amount of time for each step of the method may be varied depending on the concentrations of the substrates. For example, increasing the temperature of the method may result in faster reaction kinetics and shorten the incubation time before detection.

The method may be carried out at any suitable temperature. In some embodiments, the temperature is between about 5° C. and about 50° C., for example, 5° C., 10° C., 15° C., 20° C., 25° C., 30° C., 35° C., 40° C., 45° C., or 50° C.; or the temperature is from any of the temperatures listed above to any other of the temperatures listed above. In some embodiments, the temperature is about room temperature.

In yet another aspect, the disclosure provides a kit for detecting copper(II) in a liquid sample. In the context of the present disclosure, a skilled person would understand that the kit would include one or more containers comprising components for carrying out the method of the present disclosure, and a set of instructions for use. In some cases, all of the components are provided in the kit. In other embodiments, some components may be external to the kit. For example, a user may be required to obtain a suitable halide in salt form (e.g. NaCl) and add a desired amount at an appropriate time when carrying out the method.

In one embodiment, the kit comprises a suitable halide solution, a suitable chromogen solution, and a suitable oxidizer solution, in more than one container. In some embodiments, the solutions are in separate containers and are added together with a liquid sample to detect copper in the liquid sample.

In one embodiment, the kit comprises a first container comprising a suitable halide, such as chloride or bromide; a second container comprising a chromogen, such as TMB; and a third container comprising an oxidizer, such as hydrogen peroxide; and a set of instructions for carrying out a method of detecting copper in a liquid sample.

In other examples, a kit is provided for detecting 30 samples. The kit includes an eye drop bottle containing about 20 mL of TMB solution, an eye drop bottle containing about 20 mL of NaCl buffer, an eye drop bottle containing about 20 mL of H₂O₂ solution, an empty eye drop bottle for storing a liquid sample and detachable well strips used for reaction vessels.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

### EXAMPLES

### Example 1—Materials and Instrumentation

Hydrogen peroxide (H₂O₂, 30%), 3,3,5,5-tetramethylbenzidine (TMB, ≥99%), 2,2′-azino-bis(3-ethylbenzothiazoline-6-sulphonic acid) (ABTS), (DAB), 2-(N-morpholino)ethanesulfonic acid (MES), were obtained from Sigma-Aldrich. Guaiacol, o-phenylenediamine (OPD), o-dianisidine (ODA), terephthalic acid (TPA, ≥98%) were received from Alfa Aesar. Cu(NO₃)₂ of ultrahigh purity (99.999%) was from Alfa Aesar. NaF (≥99%), NaCl (≥99.5%), NaBr (≥99.99%), Na₂SO₄ (≥99%), NaNO₃ (≥99%), NaH₂PO₄, (≥99%), and sodium acetate (NaAC, ≥99%) were from Sigma-Aldrich. TMB was prepared in DMSO (50 mM) and stored in the dark at −70° C. prior to use.

To reduce trace contamination of other metal ions, NaCl (5M) and HCl (10 mM) solutions were treated with Chelex100 resin (final concentration 1% w/v) overnight under room temperature before use. KCl, CoCl₂, MnCl₂, MgCl₂, CaCl₂, HgCl₂, NiCl₂, Pb(NO₃)₂, FeCl₂, FeCl₃, AgNO₃, CrCl₃, AlCl₃, HAuCl₄, and mannitol were of analytical reagent grade and obtained from Sigma-Aldrich; propanol (99.9%) was purchased from Fisher Scientific, and tert-butyl alcohol (TBA, 99.5%) was obtained from Alfa Aesar; all were used without further purification. Nanopure water (18.0MΩ) prepared with a Barnstead NANO-pure system (Thermo Scientific) was used for all experiments. MES buffer was used due to its low interaction with copper²² in Fenton reactions.

Colorimetric and fluorescence measurements were performed by a M1000 Pro plate reader (TECAN, USA) using either round bottom clear 96-well polystyrene or flat bottom black 96-well polystyrene plates (COSTAR, USA). A DR 5000 UV-Vis spectrophotometer (HACH, Germany) was also used to obtain the absorbance (1 cm cuvette) for calculation of initial reaction rates. For naked eye Cu(II) detection, solution color was recorded with a digital camera. UV irradiation was performed using mineralight UVGL-25 lamp (San Gabriel, USA) at 366 nm. Identification of chlorinated TPA was performed with an Xevo G2 QTof Mass Spectrometer (Waters Limited Co., Ontario, Canada). Copper concentration in real sample (tap water) was quantified through inductively coupled plasma mass spectrometry (ICP-MS, NexION 300D, PerkinElmer, USA).

All experiments were performed at room temperature in triplicate. Error bars in each figure represent standard deviations from three repeated experiments.

### Example 2—Halides Amplify Copper-Based Fenton Reactions Via TMB

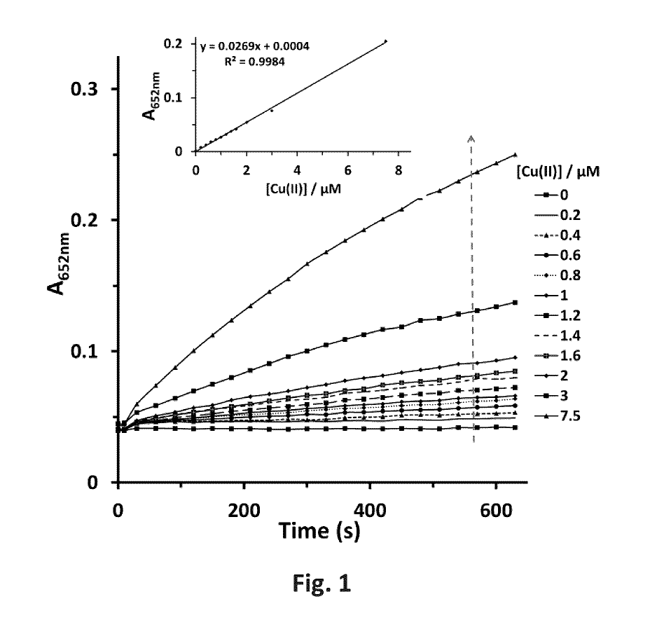

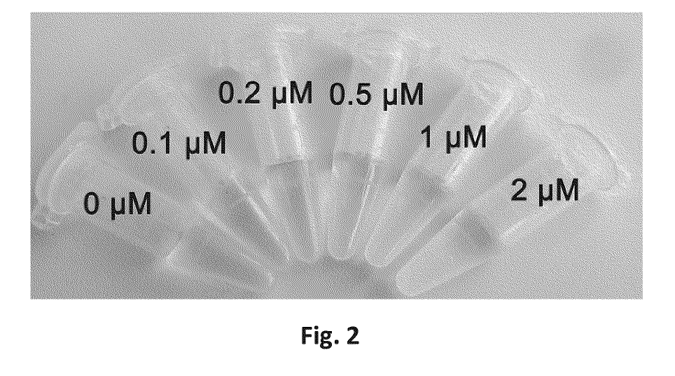

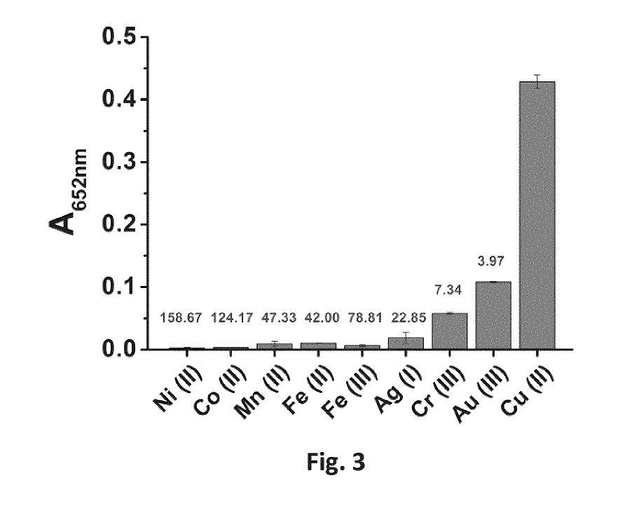

TMB can be used to detect copper based on Fenton chemistry (referred to as Cu-Fenton). The present method and composition is based on, but not limited to, the discovery that halides, such as chloride or bromide ions, can amplify the copper-based Fenton reaction, with colorimetric quantification via a widely used chromogenic substrate 3,3′,5,5′-tetramethylbenzidine (TMB) as an exemplary substrate. When H₂O₂ was added (final concentration 750 mM) to the MES buffer (2 mM, pH 5.5) containing Cu(II) and TMB (0.5 mM), the bluish oxidized TMB (ox-TMB, with maximal light absorbance at 652 nm, i.e., A₆₅₂) was generated, facilitating a colorimetric assay with a limit of detection (LOD, 3σ) of ˜200 nM (FIG. 1) and visual LOD of ˜2 μM (FIG. 2), which is 10 times lower than the drinking water limit set by the U.S. Environmental Protection Agency (1.3 ppm, or 20 μM). FIG. 1 shows TMB oxidation kinetics catalysed by different concentration of Cu(II) via Cu-Fenton chemistry. The reaction conditions are 2 mM pH 5.5 MES with 0.5 mM TMB and 750 mM H₂O₂, with a reaction time of 10 min. FIG. 1 insert shows absorbance of ox-TMB versus [Cu(II)]. FIG. 2 shows the results of a colorimetric assay of Cu(II) based on Cu-Fenton chemistry. However, this approach is not practically useful due to compromised selectivity (FIG. 3) as at micromolar concentrations, other metal ions such as Fe(II), Cr(III), Ag(I) and Au(III) can also facilitate TMB oxidation via Fenton chemistry (Fe and Cr) or by direct oxidation (Ag and Au). FIG. 3 shows the A652 (indicator of ox-TMB) generated in the presence of various metal ions (10 μM) in the TMB-H₂O₂ system; [H₂O₂]=750 mM, pH=5.5, and reaction time was 10 min. The number above each bar shows fold increase in A652 of Cu(II) catalyzed ox-TMB formation over that of the metal ions alone.

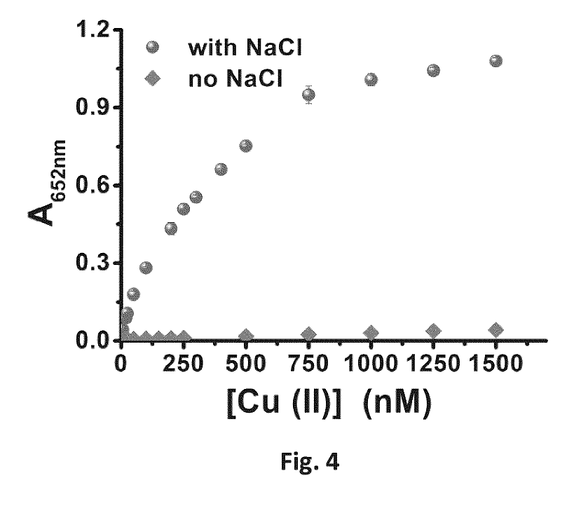

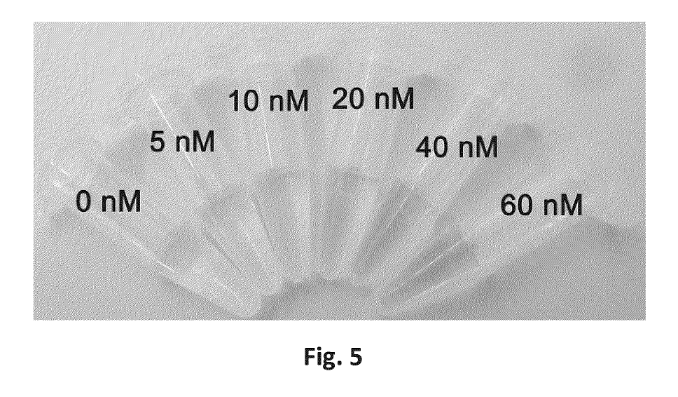

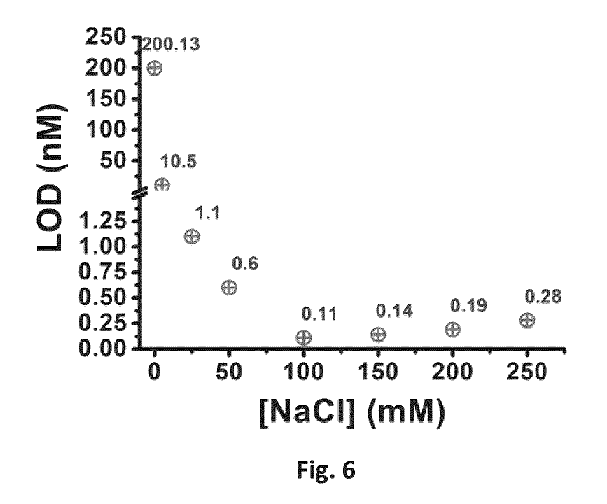

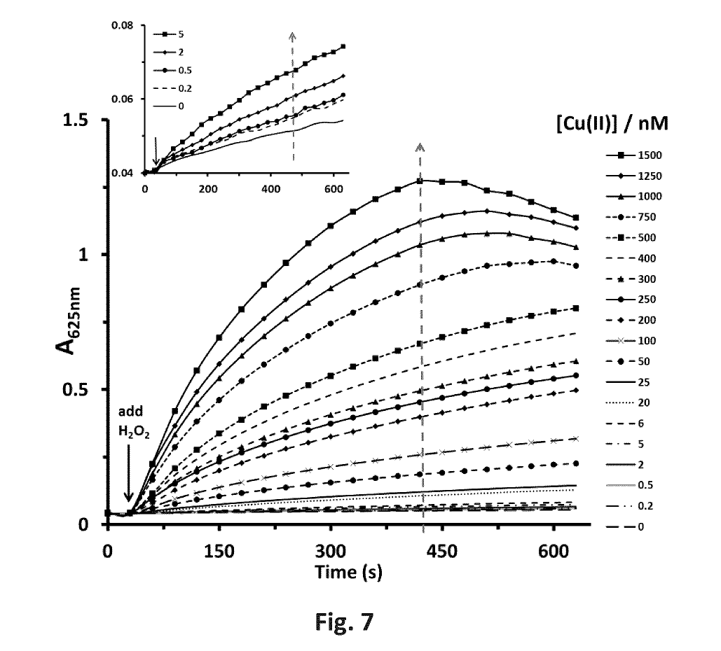

The sensitivity of the aforementioned copper assay is enhanced in the presence of chloride ions (referred to herein as “chloride-amplified Cu-Fenton” or “CA Cu-Fenton”). When 250 mM NaCl was introduced into the reaction system (containing Cu(II), H₂O₂, and TMB in MES buffer), the developed chromogen color intensity (A₆₅₂) was amplified ˜100 times (i.e., 0.5120±0.0084 vs. 0.0055±0.0009 without NaCl, n=3. FIG. 4). FIG. 4 shows the absorbance of ox-TMB catalyzed by different concentration of Cu(II) in the presence/absence of NaCl. FIG. 4. insert shows typical pictures of 200 nM Cu(II) catalysed TMB oxidation with or without NaCl (100 mM). This signal amplification endows the assay with high sensitivity for visual detection of ppb levels of waterborne copper. When using 100 mM NaCl in a 10-min assay, the LOD was 40 nM (FIG. 5) by naked eyes and 0.11 nM by a microplate-reader (FIGS. 6 and 7), with the dynamic range up to 750 nM (FIGS. 4 and 7). FIG. 5 show the results of a colorimetric assay of Cu(II) based on chloride amplified Cu-Fenton (CA Cu-Fenton) reaction. FIG. 6 shows the Cu(II) detection limit relative to NaCl concentration. LOD of 0.11 nM was achieved at 100 mM NaCl. The reaction conditions were 2 mM MES, pH 5.5 with 0.5 mM TMB, 750 mM H₂O₂, with a reaction time 10 min. FIG. 7 shows the kinetics of TMB oxidation catalysed by different concentrations of Cu(II) in the presence of 100 mM NaCl. FIG. 7 inset shows the responses at low Cu(II) levels. The reaction conditions were 2 mM MES, pH 5.5 with 0.5 mM TMB, 750 mM H₂O₂.

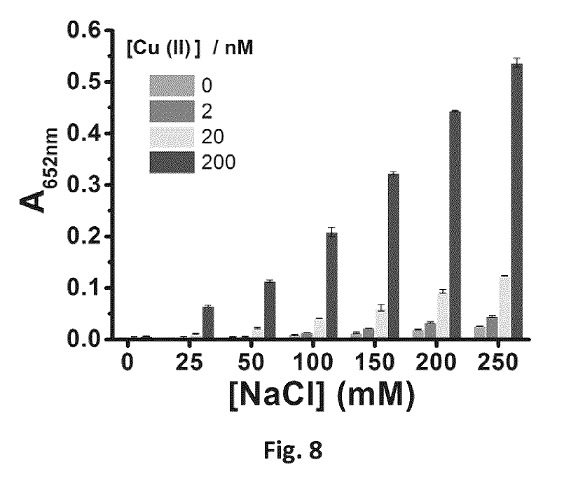

Signal amplification as a function of Cl⁻ and Cu(II) concentrations may demonstrate a synergistic catalytic effect of chloride with copper on TMB oxidation by H₂O₂to amplify developed chromogen intensity with increased chloride concentration (FIG. 8). However, high chloride concentrations can result in elevated background noise (FIG. 8, when [Cu(II)]=0). In addition, it was observed that the bluish ox-TMB aggregated over time with high NaCl concentrations (e.g. >250 mM over 10 min), which affected assay quantitation. FIG. 8 shows TMB oxidation catalyzed by CA Cu-Fenton with varying Cu(II) and NaCl concentrations. The LODs over chloride concentrations are shown in FIG. 6. Combining the results shown in FIGS. 6 and 8, a sensitivity of 0.11 nM was achieved with 100 mM NaCl, and this concentration was used for signal amplification in further experiments.

### Example 3—Signal Amplification is Attributable to Chloride Ions

Reaction kinetics was recorded by the plate-reader in kinetic mode by monitoring the absorbance change at 652 nm at room temperature. Unless stated otherwise, the experiments were performed in plate wells in 200 μL MES buffer (2 mM, pH 5.5) containing 0.5 mM TMB, 100 mM NaCl and differing concentrations of Cu(II), followed by the addition of H₂O₂ to a final concentration of 750 mM to start the reaction for 10 min.

To identify whether Na⁺ or Cl⁻ contributed to the colorimetric assay, we compared several salts of similar concentrations, including NaCl (100 mM), KCl (100 mM), Na₂SO₄ (100 mM), CH₃COONa (NaAC, 100 mM), NaNO₃ (100 mM), NaH₂PO₄ (100 mM), MgCl₂ (50 mM) and CaCl₂ (50 mM), with the Cu(II) concentration maintained at 200 nM.

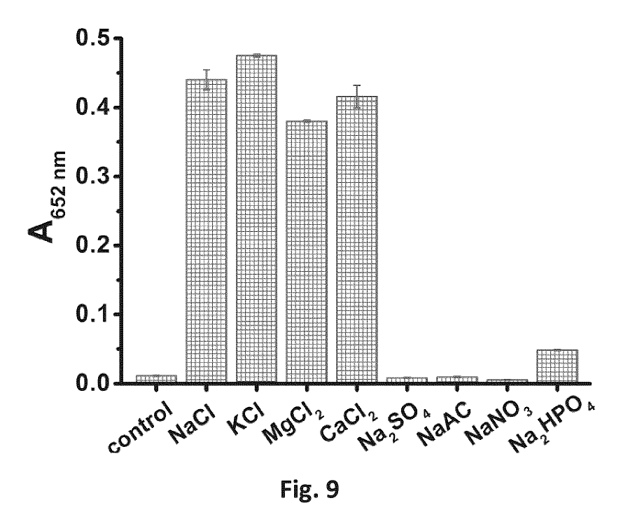

Such signal amplification was attributable to chloride anions rather than sodium cations upon comparisons of NaCl, KCl, MgCl₂, CaCl₂, Na₂SO₄, CH₃COONa (NaAC), NaNO₃, NaH₂PO₄ on color development (FIG. 9). FIG. 9 shows the effects of different anions and cations on the TMB oxidation.

### Example 4—Chloride Based Signal Amplification Enhances Chromogenic Reagents

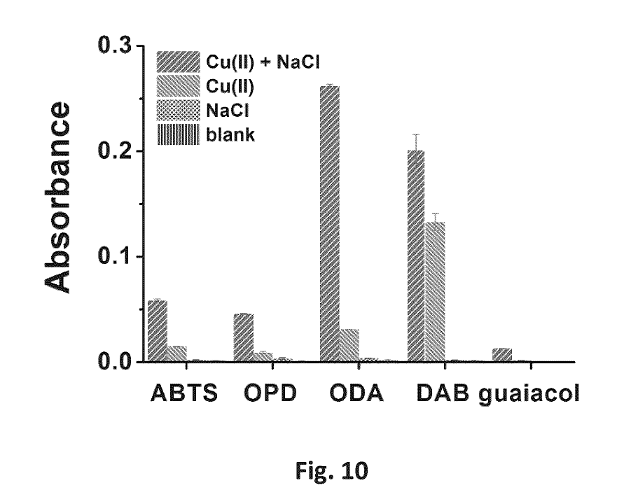

To understand the universality of the assay to other chromogenic substrates, color development was evaluated with several chromogenic substrates. It was found that the chloride based signal amplification is fairly universal, enhancing other chromogenic reagents including 2,2′-azino-bis(3-ethylbenzothiazoline-6-sulphonic acid (ABTS) (A₄₁₅), o-phenylenediamine (OPD) (A₄₂₀), guaiacol (A₄₇₀), o-dianisidine (ODA) (A₄₆₀), and diaminobenziidine (DAB) (A₄₆₅) (FIG. 10). However, signal amplification magnitude differs for each chromogen. The reactions were performed in the presence of 200 nM Cu(II) and 100 mM NaCl. FIG. 10 shows the absorbance of different oxidized chromogenic substrates (0.5 mM) by 750 mM H₂O₂ for 10 min with 2 μM Cu (II) alone, 2 μM Cu(II)+10 0mM NaCl, 100 mM NaCl alone, or neither Cu(II) nor NaCl. The detecting wavelength was 415 nm for ABTS, 420 nm for OPD, 470 nm for guaiacol, 460 nm for ODA, and 465 nm for DAB, respectively.

### Example 5—Chloride Ions Enhance Selectivity for Cu(II)

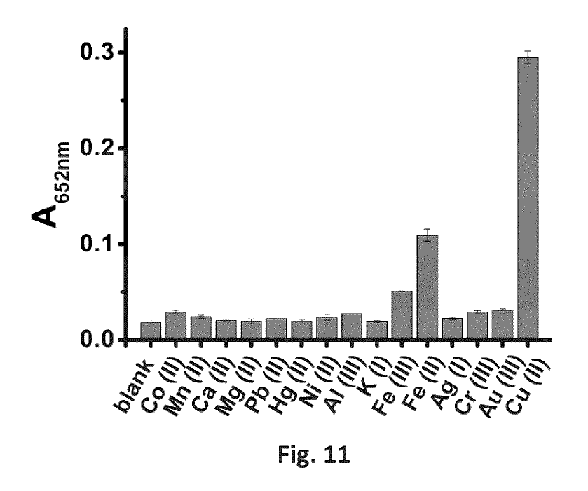

In the metal selectivity experiment, the catalytic activity of 0.1 μM Cu(II) was compared with that of 10 μM Co(II), Mn(II), Ca(II), Mg(II), Pb(II), Hg(II), Ni(II), Al(III), K(I), Fe(III), Fe(II) and Ag(I), and 1 μM Cr(III), and Au(III) (FIG. 11). FIG. 11 shows the selectivity of an assay for Cu(II) against other metal cations. Based on the calculation of Liu,^{2g} signal intensity produced by Cu(II) is ˜1000 times higher than that of Co(II), Mn(II), Ca(II), Mg(II), Pb(II), Hg(II), Ni(II), Al(III) and K(I), and ˜400 times that of Fe(III), Fe(II), and Ag(I) and ˜50 times that of Cr(III) and Au(III). These results demonstrate that chloride ions not only amplify assay sensitivity, but also enhance selectivity for Cu(II) relative to other metal ions.

### Example 6—The Role of pH on Signal Amplification

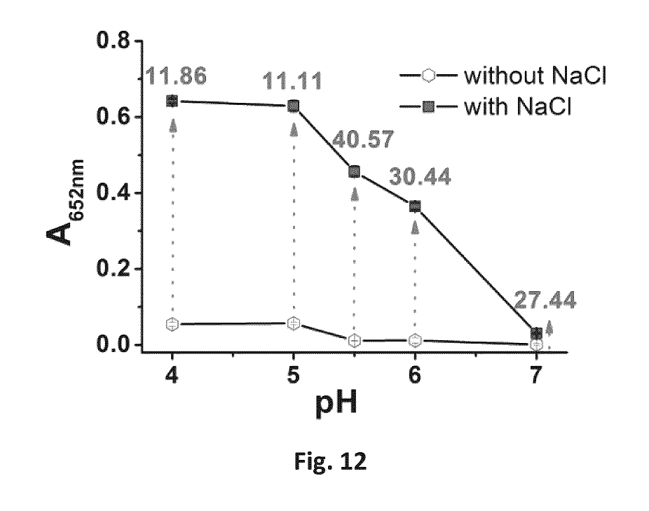

Signal amplification was 40.5 times under pH 5.5 for CA-Fenton (FIG. 12), while Fenton reactions based on Fe(II) or Fe(III) are optimal under pH 3.⁴ FIG. 5 shows the signal amplification of NaCl activated Cu-Fenton reaction (10 min) under different pH regimes; [Cu(II)]=200 nM, NaCl=100 mM. The number on each data point with NaCl stands for the magnitude of signal amplification with Cl— (A652 with NaCl/A652 without NaCl)

### Example 7—The Hydroxyl Radical is Not the Primary Reactive Oxygen Species Responsible for TMB Oxidation in the Presence of Chloride

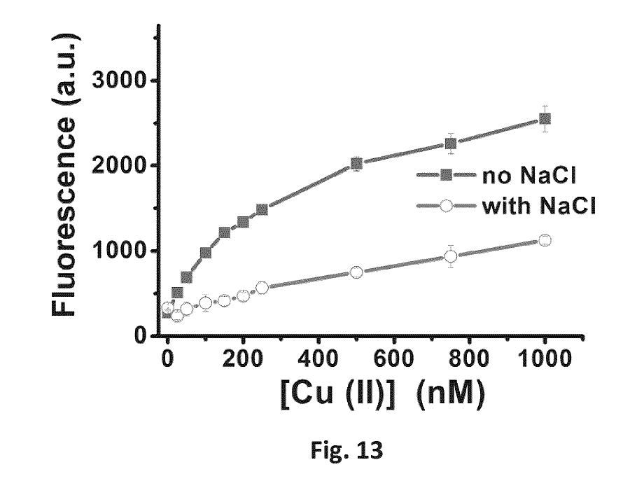

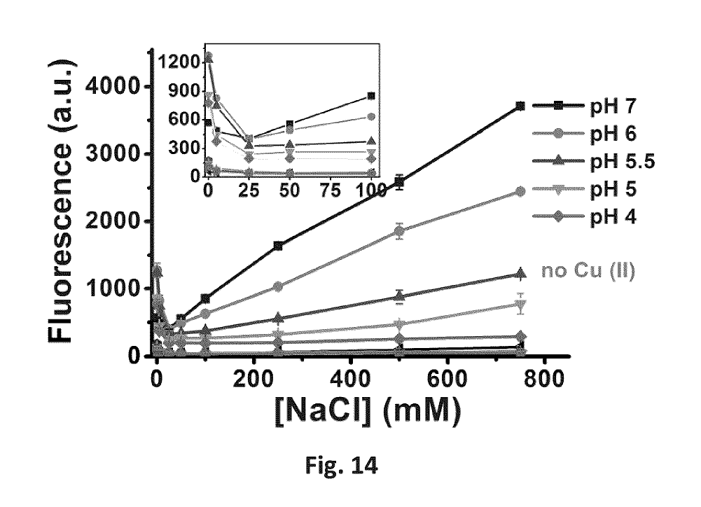

Copper(II) is an established Fenton reagent that can react with oxygen or peroxide to generate highly reactive oxygen species (ROSs), such as superoxide anion (.O₂⁻) and hydroxyl radical (.OH).⁵ It was intuitively expected that .OH, as the most reactive ROS, was responsible for directly oxidizing TMB to generate the bluish product, since this was true when no NaCl was added. Without NaCl, TMB oxidation-induced color development is positively correlated with Cu(II) and .OH concentrations produced by the Cu-Fenton reaction, as determined by terephthalic acid (TPA), a sensitive substrate that can quantitatively react with .OH to form a hydroxylated product (TPA-OH) with strong fluorescence properties⁶ (Inset, FIG. 13). FIG. 13 shows the hydroxyl radical yield detected with terephthalic acid (TPA)²³ as a function of Cu(II) concentration with or without NaCl. FIG. 13 inset shows hydroxylation of TPA with .OH to form fluorescent product 2-hydroxyterephthalate. However, when the .OH yields were measured in the system with added NaCl (25 mM) at pH 5.5, the amount of .OH decreased to ˜30% of its initial value prior to NaCl addition (FIG. 14 and inset). With addition of 250 mM NaCl, .OH yields increased slowly to ˜40% of its initial levels. FIG. 14 shows the effect of NaCl concentration on the .OH production under different pHs in the CA Cu-Fenton system; the system without Cu(II) served as the control. FIG. 14 inset shows the .OH production with ≤100 mM NaCl.

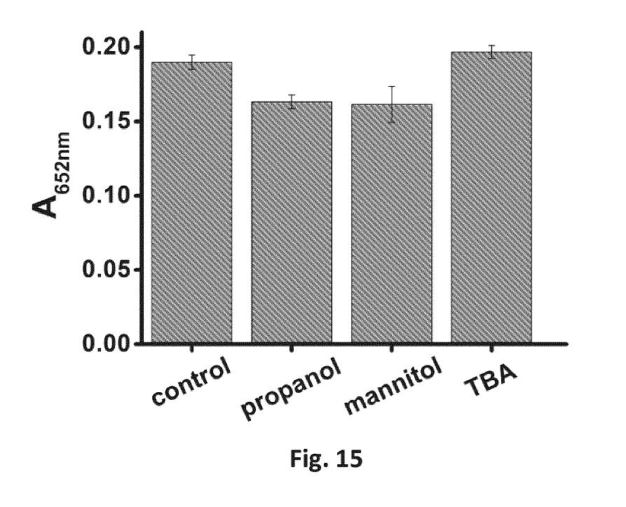

There was a clear decrease in .OH generation in the presence of Cl⁻ (FIGS. 13 and 14), despite more ox-TMB production in the presence of Cl⁻ anions (FIGS. 4 and 8). The effect of ROS scavengers on NaCl activated Cu(II) Fenton reaction was investigated using 600 mM propanol, 100 mM mannitol, or 500 mM tert-butyl alcohol (TBA) as scavengers; 200 nM Cu(II) was used with a 5 min reaction time. Hydroxyl radical concentration was monitored using the TPA method²³ where 0.5 mM TPA was used to monitor .OH under differing NaCl concentrations (0-250 mM) and pH regimes (4.0-7.0) in MES solution. It was observed that the fluorescence intensity of TPA-OH was pH dependent; therefore, the fluorescence intensity data of TPA-OH under different pHs were normalized to that under pH 5.5 to correct for the pH dependent variation (FIG. 15). FIG. 15 shows the scavenging effect of propanol, mannitol and tert-butyl alcohol (TBA) on TMB oxidation in CA Cu-Fenton systems.

### Example 8—Chloride Anions Enhance TMB Oxidation

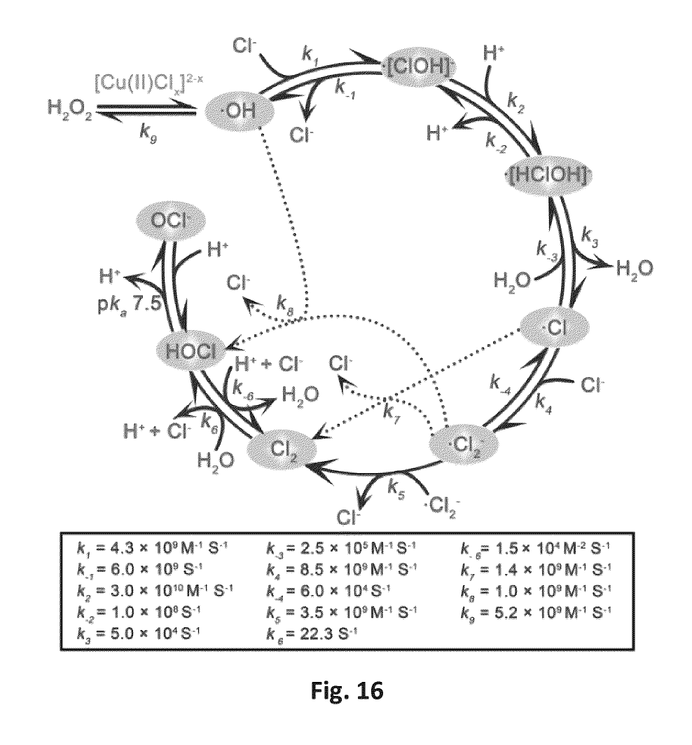

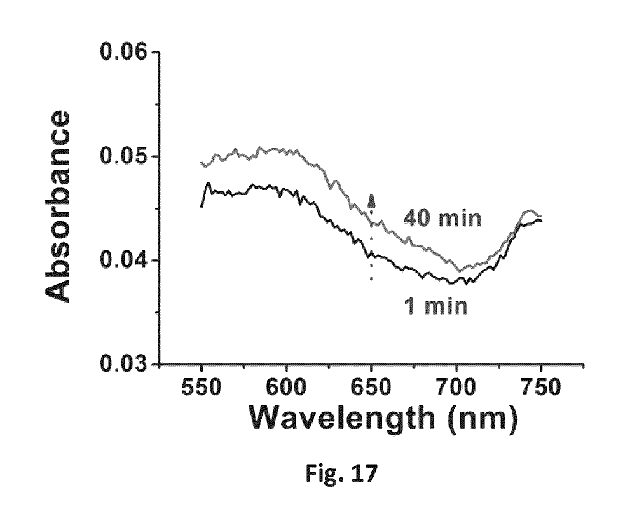

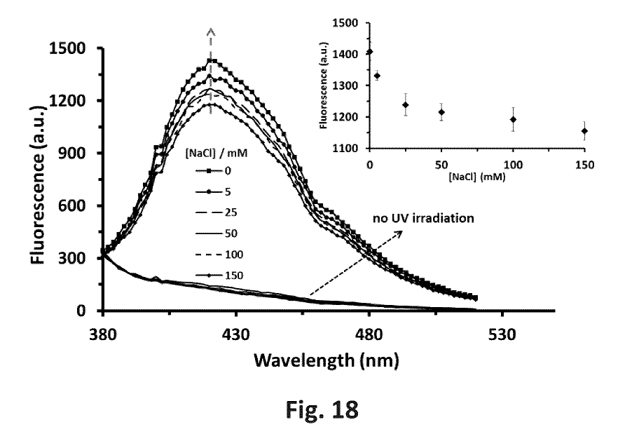

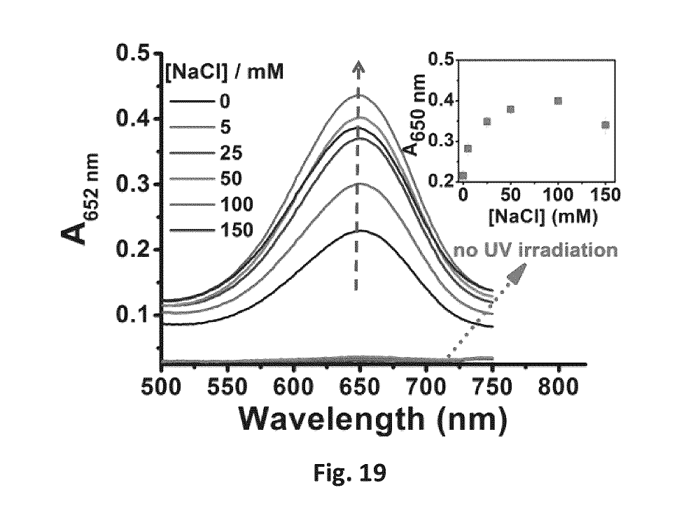

Chloride anions are demonstrated scavengers of .OH and are consequently easily oxidized to form chloride radicals (.Cl) and then to dichloride anion radicals (.Cl₂⁻),⁷ as shown in FIG. 16. FIG. 16 shows the chemical reaction of relevant species with reaction constants or pKₐ²⁴. Since .Cl (Eº(.Cl/Cl⁻)=2.41 V) and .Cl₂⁻ (Eº(.Cl₂⁻/2Cl⁻)=2.09 V) are much less reactive than .OH (Eº(.OH, H⁺/H₂O)=2.73 V),⁸ their steady-state concentrations should be significantly higher than that of .OH.^{7a-c} Further, the spontaneous self-coupling annihilation products of chloride radicals such as chlorine (Cl_{2(aq)}) or hypochloric acid (FIG. 16), can themselves oxidize TMB to OX-TMB;⁹ however, the self-annihilation of .OH generates H₂O₂(FIG. 16), which hardly oxidize TMB even in 3M over 40 min (FIG. 17). FIG. 17 shows the UV-vis spectra of TMB at 1- and 40-mins of incubation with 3M H₂O₂ in 2 mM MES, pH 5.5. Consequently, it is reasonable that chloride radicals may be largely responsible for observed TMB oxidation. To evaluate how hydroxyl radical/reactive chlorine transformation affected TMB oxidation, an experiment was performed in a photo-Fenton reaction system (UV/H₂O₂/TMB) with .OH generated by UV induced homolysis of H₂O₂ (H₂O₂+UV→2.OH).¹⁰ In the presence of NaCl, chloride radicals were generated by .OH oxidation.¹¹ The mixture of 0.5 mM TMB and 750 mM H₂O₂ in 200 μL MES buffer (2 mM, pH 5.5) in UV-transparent 96-well plate (Greiner, Bio One GmbH, Frickenhausen, Germany) was placed on a UV lamp and irradiated at 366 nm for 150 seconds; the reactions were then quickly recorded by plate reader at 650 nm. Similarly, Cl—([NaCl]=100 mM) on .OH radical transformation was studied with the UV/H₂O₂/TPA system. After irradiation for 150 seconds, fluorescence was quickly recorded by excitation at 310 nm and emission at 420 nm. The .OH yield decreased with increasing NaCl (FIG. 18), while ox-TMB increased by 50% (A₆₅₂ increasing from 0.2 to 0.4) at 100 mM NaCl (FIG. 19). FIG. 18 shows the fluorescence spectra of TPA/H₂O₂ irradiated at 365 nm for 150 s at the presence of different concentrations of NaCl. FIG. 18 inset shows a plot of the emission at 420 nm (indication of the .OH concentration) versus the concentration of NaCl. FIG. 19 shows the UV-vis absorbance spectra of TMB oxidation by H₂O₂ in photo-Fenton reaction where the samples were irradiated at 365 nm for 150 s with different concentrations of NaCl. FIG. 19 inset shows a plot of the A650 (indication of the ox-TMB concentration) versus the concentration of NaCl. The decrease of ox-TMB at 150 mM NaCl may be due to instability in higher salt concentrations.

### Example 9—Chloride Anions Enhance TMB Oxidation by Complexing with Cu(II)

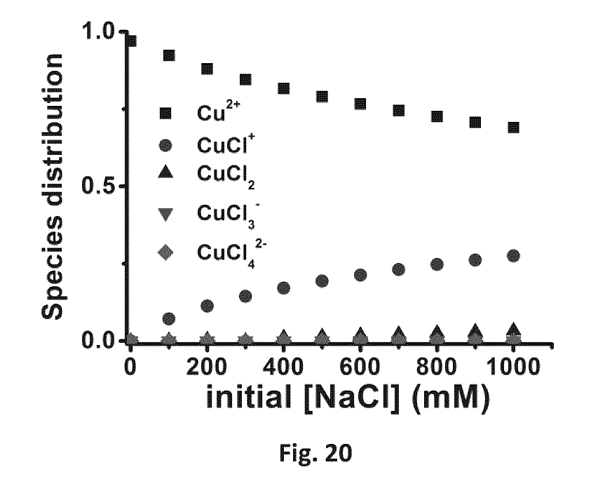

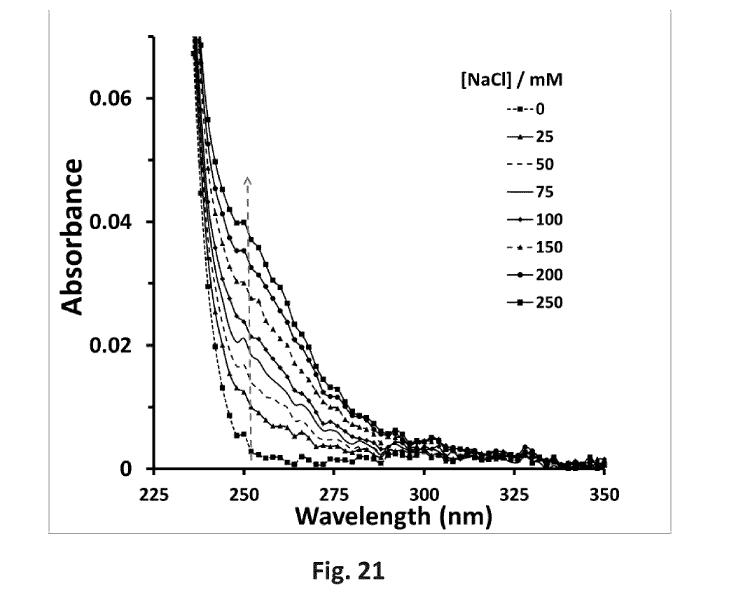

Without being bound by theory, it is believed that chloride ions can enhance the Cu(II)-catalysed decomposition of H₂O₂ by decreasing the activation energy.¹² The main complex in the present 100 mM NaCl system is [CuCl]⁺ based on calculations (FIG. 20) and data (FIG. 21) demonstrating increased absorbance (λ=250 nm) with increasing concentration of NaCl added to a 0.2 mM Cu(II) solution, consistent with previous work.¹³ FIG. 20 shows the calculated Cu(II) species formation and distribution at pH 5.5 under variable initial NaCl concentrations from 0-1.0M using PhreeqC modelling code. FIG. 21 shows the UV-vis spectra of Cu(II)-chloride complex in 2 mM MES buffer (pH 5.5). The experiment was performed by mixing varying NaCl concentrations with a 200 μM of Cu(II) for UV absorbance measurement.

To study the effect of NaCl concentration on the initial TMB oxidation reaction rates, the apparent steady-state reaction rates at different NaCl concentrations (0-250 mM) and Cu(II) concentrations (2, 20, and 200 nM, respectively) were obtained by measuring absorbance changes within 220 seconds after H₂O₂ addition, which is within the linear phase of the reaction kinetics. The slopes of linear kinetic trend-lines change were used to calculate the initial reaction rates, where concentration changes within the first 220 seconds were calculated using the Beer-Lambert Law with a molar absorption coefficient of 39 000 M-1 cm-1 for ox-TMB. The measured reaction rates for 2 nM Cu(II) were also reported as turnover frequencies (TOF) and are measured in molecules of ox-TMB produced per Cu(II) atom per second of reaction time.

To monitor the presence of the [CuCl]⁺ complex, the UV absorbance spectra was recorded with 200 μM Cu(II) and increasing concentrations of NaCl (0-250 mM) in 2 mM MES solution with different pHs (4.0-7.0) within UV transparent 96 well plates.

To monitor the generation of active chloride species (ACSs) and their functions, chlorinated TPAs were identified in the hydroxylation experiments in the presence of 100 mM NaCl. We collected 100 μL of each liquid sample and mixed with 900 μL of pure methanol (Fisher Optima solvent) for direct infusion based full scan analysis with the Xevo G2 QTof Mass Spectrometer under negative ionization mode. The key experimental parameters were as follows. Capillary voltage −4.00 KV; cone voltage −20V; extractor voltage −3V; radio frequency lens voltage −0.2V; source temperature: 125° C.; desolvation temperature 300° C.; cone gas (N₂) flow rate OL/h; desolvation gas (N₂) flow rate 600 L/h; perfusion flow 10 μL/min.

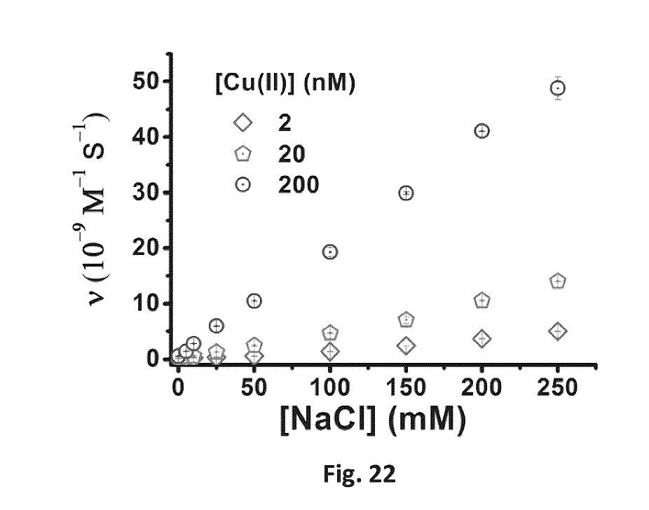

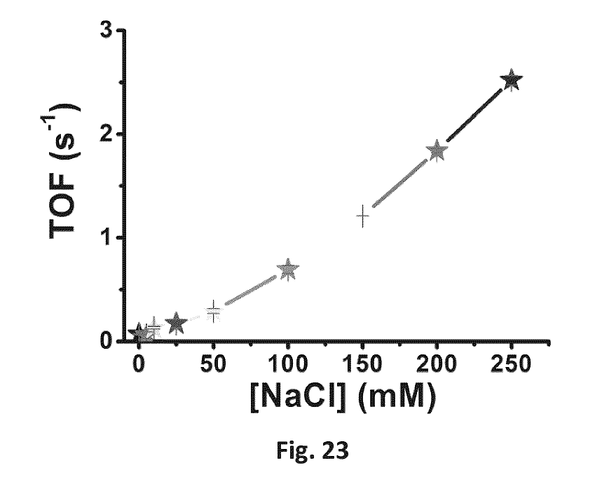

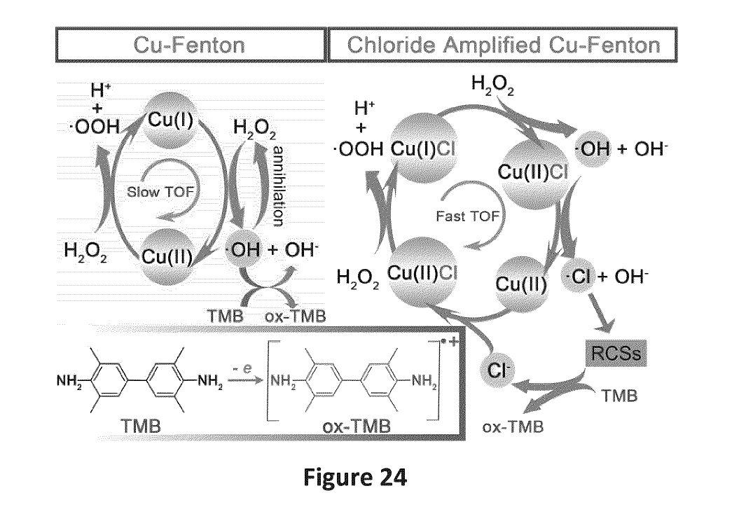

The positive correlation between chloride concentration and initial rate of TMB oxidation (FIG. 22) or the turnover frequency (TOF, FIG. 23) is further evidence of the synergistic catalytic activity of copper and chloride. FIG. 22 shows a plot of the initial rate of TMB oxidation versus NaCl concentration at different Cu(II) concentrations. FIG. 23 is the turnover frequency (TOF) of CA-Cu-Fenton reaction with different concentrations of NaCl. As increasing [NaCl] did not plateau reaction rates or TOF, the catalytic activity of copper complexes may be ordered: [CuCl₄]²⁻>[CuCl₃]⁻>[CuCl₂]>[CuCl]⁺>Cu(II).¹² Since the binding of Cl⁻ to Cu(I) is much stronger than Cu(II), it facilitates the Cu(II)→Cu(I) transformation,¹⁴ which is assumed the rate limiting step in Cu-Fenton,^{5a} which commensurately increases Cu(II)→Cu (I)→Cu(II) cycling to more rapidly generate .OH. The catalytic activity of Cl⁻ demonstrated in reducing Cu(II)→C(I) in electrodeposition¹⁵, may contribute to accelerated Cu-Fenton cycling, but not substantial, due to the concentration dependent activity of Cl⁻ in CA Cu-Fenton. Further, the formation of [Cu(Cl)ₓ(H₂O₂)_{y}]^{2-x} and [Cu(Cl)ₓ(H₂O₂)_{y}]^{1-x} complexes may facilitate generation of RCSs in situ (i.e., Cl is directly generated from the complexes via inner sphere electron-transfer from .OH). This would significantly increase the RCSs generation rate relative to the oxidation of chloride ions by .OH via outer sphere electron-transfer in bulk solution, given that the reaction is virtually diffusion-rate controlled and both .OH and .Cl are short lived species with limited migration capability in buffer.^{7e,7g,16} Experimental evidence demonstrates more .OH were generated with increasing NaCl concentrations at both pH 6 and 7 (FIG. 14) with .OH yield increased by ˜7 times in 750 mM NaCl under pH 7. At lower pHs, there was no net increase of the .OH yield, which is attributed to the higher oxidizing capability (i.e., higher Eº) of .OH in acidic solutions and thus more complete transformation to RCSc.^{7b,8,11} The existence of RCSs was substantiated with the observation of significant amounts of chlorinated terephthalic acid (TPA-Clₓ) in the Mass Spectrometry experiment (data not shown); in the CA Cu-Fenton system with 100 mM NaCl added, chlorinated products (including TPA-Cl₃ and TPA-Cl₄) dominated as products, while only TPA-OH was generated in the Cu-Fenton system when NaCl was absent. The proposed mechanism of Cu-Fenton and Chloride Amplified Cu-Fenton reaction on the oxidation of TMB is shown in FIG. 24.

### Example 10—Comparing the Effects of Chloride Anions with Other Halogen Anions

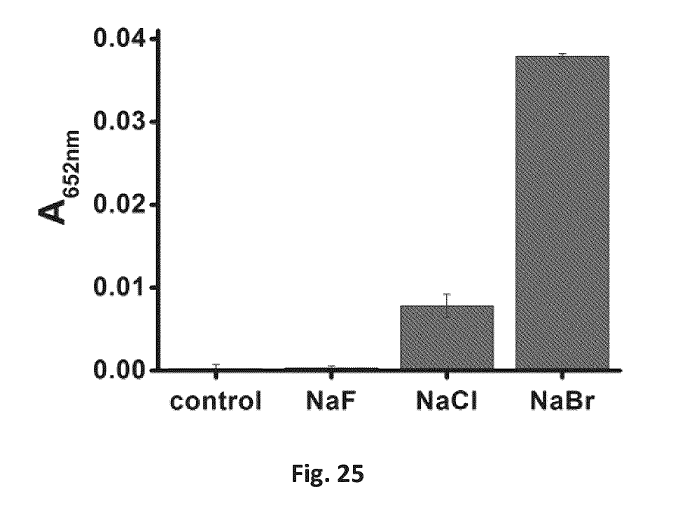

Comparing the effect with other halogen anions on the assay, it was demonstrated that Br⁻ could potentially provide even higher signal amplification than Cl⁻ (FIG. 25). F⁻ was not found to be as effective at the parameters tested, likely attributing to its high reduction potential (Eº(.F/F⁻)=3.6 V).⁸ I⁻ was not tested due to possible redox reaction with Cu(II).¹⁸ Both Cl⁻ and Br⁻ have been shown to be weak activators on H₂O₂ decomposition possibly through a cycling of halogen anions and halogen atoms (X⁻↔.X),¹⁹ although the catalytic activity of either X⁻ or Cu(II) alone was negligible compared to CuX⁺ complex in our system (FIG. 8). The reactive halogen species produced therefore further oxidize TMB thus resulting in the color development, accounting for the background A₆₅₂ in the absence of Cu(II) (FIG. 8). In the assay, Cl⁻ was selected over Br⁻ for lower background noise. Herein, the halogen atoms are radicals²⁰ with high reactivity towards other organic compounds, including the oxidation of TMB and/or halogenation of organic molecules, especially the aromatic ones such as TPA.

### Example 11—Evaluating Copper Ions in Tap Water

As copper historically and currently enjoys widespread use in household water supply lines systems, corrosion can result in drinking water contamination, particularly when infrequently used. To demonstrate the feasibility of the present colorimetric assay, copper ions were evaluated in the tap water followed by validation with inductively coupled plasma mass spectrometry (ICP-MS).

Analysis of tap water samples was carried out using standard addition method. A water sample was collected from the inventor's laboratory and was filtered through 0.45 μm Teflon filter before analysis. Aliquots of this tap water were spiked with standard Cu(II) solutions (0-3 μM) that had been prepared in 2 mM MES solution with pH 5.5. The spiked samples were then analyzed separately using both ICP-MS and the present sensing technique. Quantitation for both methods was obtained by calibration by the standard addition method. The determined copper concentration with the present method (n=5) was 4.50(±0.23) μM, consistent with that obtained with the ICP-MS, i.e., 4.26(±0.12), (t-test 2.07; <2.31 at 95% confidence level).

To ascertain the dominant copper chloride formed in the solution observed in the experiment, Cu species distributions were calculation using PhreeqC Interactive Version 3.0.6-7757 with Minteq.V4 thermodynamic database (USGS, Denver, Colo.: 2013).

### REFERENCES

(1) (a) Barnham, K. J.; Masters. C. L.; Bush, A. I. Nature Reviews Drug Discovery 2004, 3, 2005. (b) Que, E. L.; Domaille, D. W.; Chang, C. J. Chem. Rev. 2008, 108, 1517. (c) Bull, P. C.; Thomas, G. R.; Rommens, J. M.; Forbes, J. R.; Cox, D. W. Nat. Genet. 1993, 5, 327. (d) Gaggelli, E.; Kozlowski, H.; Valensin, D.; Valensin, G. Chem. Rev. 2006, 106, 1995. (e) Waggoner, D. J.; Bartnikas, T. B.; Gitlin, J. D. Neurobiol. Dis. 1999, 6, 221. (f) Rivera-Mancía, S.; Pérez-Neri, I.; Rios, C.; Tristán-López, L.; Rivera-Espinosa, L.; Montes, S. Chem. Biol. Interact. 2010, 186, 184.

(2) (a) Zhang, Z.; Li, W.; Zhao, Q.; Cheng, M.; Xu, L.; Fang, X. Biosens. Bioelectron. 2014, 59, 40. (b) Lu, C. -H.; Wang, Y. -W.; Ye, S. -L.; Chen, G. -N.; Yang, H. -H. NPG Asia Materials 2012, 4, e10. (c) Zhang, L. -p.; Xing, Y. -p.; Liu, C.; Zhou, X. -h.; Shi, H. -c. Sensors Actuators B: Chem. 2015, 215, 561. (d) Jin, L. -H.; Han, C. -S. Anal. Chem. 2014, 86, 7209. (e) Chan, Y. -H.; Chen, J.; Liu, Q.; Wark, S. E.; Son, D. H.; Batteas, J. D. Anal. Chem. 2010, 82, 3671. (f) Gattás-Asfura, K. M.; Leblanc, R. M. Chem. Commun. 2003, 2684. (g) Liu, J.; Lu, Y. J. Am. Chem. Soc. 2007, 129, 9838. (h) Yin, B. -C.; Ye, B. -C.; Tan, W.; Wang, H.; Xie, C. -C. J. Am. Chem. Soc. 2009, 131, 14624. (i) Li, W.; Zhao, X.; Zhang, J.; Fu, Y. Biosens. Bioelectron. 2014, 60, 252. (j) Yang, Y. Chem. Commun. 2009, 6171. (k) Ruan, Y. -B.; Li, C.; Tang, J.; Xie, J. Chem. Commun. 2010, 46, 9220. (l) Lin, W.; Long, L.; Chen, B.; Tan, W.; Gao, W. Chem. Commun. 2010, 46, 1311. (m) Kovács, J.; Mokhir, A. Inorg. Chem. 2008, 47, 1880. (n) Kovács, J.; Rödler, T.; Mokhir, A. Angew. Chem. 2006, 118, 7979. (o) Jo, J.; Lee, H. Y.; Liu, W.; Olasz, A. s.; Chen, C. -H.; Lee, D. J. Am. Chem. Soc. 2012, 134, 16000. (p) Tan, Z. -q.; Liu, J. -f.; Jiang, G. -b. Nanoscale 2012, 4, 6735. (q) Xu, X.; Daniel, W. L.; Wei, W.; Mirkin, C. A. Small 2010, 6, 623. (r) Zhou, Y.; Wang, S.; Zhang, K.; Jiang, X. Angew. Chem. 2008, 120, 7564. (s) Yao, Z.; Yang, Y.; Chen, X.; Hu, X.; Zhang, L.; Liu, L.; Zhao, Y.; Wu, H. -C. Anal. Chem. 2013, 85, 5650. (t) Kumar, M.; Kumar, N.; Bhalla, V.; Sharma, P. R.; Kaur, T. Org. Lett. 2011, 14, 406. (u) Wang, P.; Lei, J.; Su, M.; Liu, Y.; Hao, Q.; Ju, H. Anal. Chem. 2013, 85, 8735.

(3) (a) Ballesteros, E.; Moreno, D.; Gómez, T.; Rodriguez, T.; Rojo, J.; García-Valverde, M.; Torroba, T. Org. Lett. 2009, 11, 1269. (b) Que, E. L.; Chang, C. J. J. Am. Chem. Soc. 2006, 128, 15942. (c) Sheng, R.; Wang, P.; Gao, Y.; Wu, Y.; Liu, W.; Ma, J.; Li, H.; Wu, S. Org. Lett. 2008, 10, 5015.

(4) Kang, Y. W.; Hwang, K. -Y. Water Res. 2000, 34, 2786.

(5) (a) Bokare, A. D.; Choi, W. J. Hazard. Mater. 2014, 275, 121. (b) Allen, S. E.; Walvoord, R. R.; Padilla-Salinas, R.; Kozlowski, M. C. Chem. Rev. 2013, 113, 6234.

(6) (a) Barreto, J. C.; Smith, G. S.; Strobel, N. H.; McQuillin, P. A.; Miller, T. A. Life Sci. 1994, 56, PL89. (b) Linxiang, L.; Abe, Y.; Nagasawa, Y.; Kudo, R.; Usui, N.; lmai, K.; Mashino, T.; Mochizuki, M.; Miyata, N. Biomed. Chromatogr. 2004, 18, 470.

(7) (a) De Laat, J.; Le, T. G. Applied Catalysis B: Environmental 2006, 66, 137. (b) De Laat, J.; Le, G. T.; Legube, B. Chemosphere 2004, 55, 715. (c) Le Truong, G.; De Laat, J.; Legube, B. Water Res. 2004, 38, 2384. (d) Machulek Jr, A.; Moraes, J. E.; Vautier-Giongo, C.; Silverio, C. A.; Friedrich, L. C.; Nascimento, C. A.; Gonzalez, M. C.; Quina, F. H. Environ. Sci. Technol. 2007, 41, 8459. (e) Yu, X. -Y.; Bao, Z. -C.; Barker, J. R. The Journal of Physical Chemistry A 2004, 108, 295. (f) Devi, L. G.; Munikrishnappa, C.; Nagaraj, B.; Rajashekhar, K. E. J. Mol. Catal. A: Chem. 2013, 374, 125. (g) Nadtochenko, V.; Kiwi, J. Environ. Sci. Technol. 1998, 32, 3273.

(8) Wardman, P. J. Phys. Chem. Ref. Data 1989, 18, 1637.

(9) (a) Serrat, F. B. Talanta 1994, 41, 2091. (b) Mesquita, R. B.; Noronha, M. L. F.; Pereira, A. I.; Santos, A. C.; Torres, A. F.; Cerdà, V.; Rangel, A. O. Talanta 2007, 72, 1186.

(10) Baxendale, J.; Wilson, J. Trans. Faraday Soc. 1957, 53, 344.

(11) Liao, C. -H.; Kang, S. -F.; Wu, F. -A. Chemosphere 2001, 44, 1193.

(12) Perez-Benito, J. F. Monatshefte für Chemie/Chemical Monthly 2001, 132, 1477.

(13) (a) Zhang, N.; Zeng, D.; Hefter, G.; Chen, Q. J. Mol. Liq. 2014, 198, 200. (b) Zhang, N.; Zhou, Q.; Yin, X.; Zeng, D. J. Solution Chem. 2014, 43, 326. (c) Zhao, H.; Chang, J.; Boika, A.; Bard, A. J. Anal. Chem. 2013, 85, 7696.

(14) Collings, M. D.; Sherman, D. M.; Ragnarsdottir, K. V. Chem. Geol. 2000, 167, 65.

(15) (a) Pacioni, N. L.; Pardoe, A.; McGilvray, K. L.; Chrétien, M. N.; Scaiano, J. C. Photochemical & Photobiological Sciences 2010, 9, 766. (b) Soares, D. M.; Wasle, S.; Weil, K. G.; Doblhofer, K. J. Electroanal. Chem. 2002, 532, 353. (c) Gabrielli, C.; Moçotéguy, P.; Perrot, H.; Wiart, R. J. Electroanal. Chem. 2004, 572, 367.

(16) (a) Guo, Q.; Yue, Q.; Zhao, J.; Wang, L.; Wang, H.; Wei, X.; Liu, J.; Jia, J. Chem. Commun. 2011, 47, 11906. (b) Roots, R.; Okada, S. Radiat. Res. 1975, 64, 306. (c) Attri, P.; Kim, Y. H.; Park, D. H.; Park, J. H.; Hong, Y. J.; Uhm, H. S.; Kim, K. -N.; Fridman, A.; Choi, E. H. Sci. Rep. 2015, 5.

(17) Skudaev, V.; Solomonov, A.; Morozovskii, A.; Isakov, N. Russ. J. Appl. Chem. 2008, 81, 14.

(18) Shaffer, P. A.; Hartmann, A. J. Biol. Chem. 1921, 45, 349.

(19) (a) Bray, W. C.; Livingston, R. S. J. Am. Chem. Soc. 1923, 45, 1251. (b) Bray, W. C.; Livingston, R. S. J. Am. Chem. Soc. 1928, 50, 1654.

(20) Jayson, G.; Parsons, B.; Swallow, A. J. Journal of the Chemical Society, Faraday Transactions 1: Physical Chemistry in Condensed Phases 1973, 69, 1597.

(21) Bagirova, N. A.; Shekhovtsova, T. N.; van Huystee, R. B. Talanta 2001, 55, 1151.

(22) Yu, Q.; Kandegedara, A.; Xu, Y.; Rorabacher, D. Anal. Biochem. 1997, 253, 50.

(23) Barreto, J. C.; Smith, G. S.; Strobel, N. H.; McQuillin, P. A.; Miller, T. A. Life Sci. 1994, 56, PL89.

(24) (a) Buxton, G. V.; Greenstock, C. L.; Helman, W. P.; Ross, A. B. J. Phys. Chem. Ref. Data 1988, 17, 513. (b) Neta, P.; Huie, R. E.; Ross, A. B. J. Phys. Chem. Ref. Data 1988, 17, 1027. (c) Martell, A. E.; Smith, R. M. Critical stability constants; Springer, 1974; Vol. 1. (d) Yu, X. -Y. J. Phys. Chem. Ref. Data 2004, 33, 747. (e) Wang, T. X.; Margerum, D. W. Inorg. Chem. 1994, 33, 1050. (f) Knipping, E. M.; Dabdub, D. Journal of Geophysical Research: Atmospheres (1984-2012) 2002, 107, ACH 8.

All references cited in this document are incorporated herein by reference in their entirety.

The above-described embodiments are intended to be examples only. Alterations, modifications and variations can be effected to the particular embodiments by those of skill in the art without departing from the scope of the disclosure, which is defined solely by the claims appended hereto.

What is claimed is:

1. A method for detecting copper(II) in a liquid sample, comprising:
contacting the liquid sample with a chromogen in the presence of a suitable halide and an oxidizer; and detecting a color change of the chromogen; wherein the color change when present indicates the presence of copper in the liquid sample.

2. A method for detecting copper(II) in a liquid sample, comprising:
combining a chromogen and a suitable halide in a suitable medium to create a mixture solution;
contacting the mixture solution and the liquid sample to create a reaction solution;
adding an oxidizer to the reaction solution; and
detecting a color change of the chromogen,
wherein the color change when present indicates the presence of copper.

3. The method of claim 1 or 2, wherein the halide is chloride or bromide.

4. The method of any one of claims 1 to 3, wherein the oxidizer is hydrogen peroxide.

5. The method of any one of claims 1 to 4, wherein the chromogen is TMB.

6. The method of any one of claims 1 to 5, wherein the concentration of the halide in salt form is between about 1 mM and about 1000 mM.

7. The method of any one of claims 1 to 6, wherein the concentration of the oxidizer is between about 1 mM and about 5000 mM.

8. The method of any one of claims 1 to 7, wherein the concentration of the chromogen is between about 0.01 mM and about 1.00 mM.

9. The method of any one of claims 1 to 8, wherein the liquid sample is water.

10. The method of any one of claims 1 to 9, wherein copper is detected visually or instrumentally.

11. A composition for detecting copper(II) in a liquid sample, comprising:
a suitable halide;
a chromogen; and
an oxidizer,
wherein the chromogen undergoes a color change in the presence of copper.

12. The composition of claim 11, wherein the halide is chloride or bromide.

13. The composition of any one of claim 11 or 12, wherein the oxidizer is hydrogen peroxide.

14. The composition of any one of claims 11 to 13, wherein the chromogen is TMB.

15. The composition of any one of claims 11 to 14, wherein the concentration of the halide in salt form is between about 1 mM and about 1000 mM.

16. The composition of any one of claims 11 to 15, wherein the concentration of the oxidizer is between about 1 mM and about 5000 mM.

17. The composition of any one of claims 11 to 16, wherein the concentration of the chromogen is between about 0.01 mM and about 1.00 mM.

18. The composition of any one of claims 11 to 17, wherein the liquid sample is water.

19. The composition of any one of claims 11 to 18, wherein copper is detected visually or instrumentally.

20. A kit for detecting copper(II) in a liquid sample, the kit comprising:
a first container comprising a suitable halide;
a second container comprising a chromogen; and
a third container comprising an oxidizer; and a set of instructions for carrying out a method of detecting copper in a liquid sample.
